(19) United States
(12) Patent Application Publication
(10) Pub. No.: US 2022/0306149 A1
(43) Pub. Date: Sep. 29, 2022

(54) DEVICE FOR CONTROLLING A STEERING ANGLE OR BRAKING OF AN AUTONOMOUS MOTOR VEHICLE AND VEHICLE INCLUDING THE DEVICE

(71) Applicant: TRANSDEV GROUP INNOVATION, ISSY-LES-MOULINEAUX (FR)

(72) Inventors: Paulo Miranda, VOISINS LE BRETONNEUX (FR); Nicolas Desmoineaux, COURBEVOIE (FR); Laurent Vallot, CHARTRES (FR); Jean Michel Tainha, VERSAILLES (FR)

(21) Appl. No.: 17/655,980

(22) Filed: Mar. 22, 2022

(30) Foreign Application Priority Data
Mar. 26, 2021 (FR) 21 03097

(51) Int. Cl. B60W 60/00

(52) U.S. Cl. CPC B60W 60/001; B60T 2270/604; B62D 6/00

(57) ABSTRACT

A control device is for controlling an autonomous motor vehicle in order to modify a steering angle of a steered wheel of the autonomous motor vehicle and/or a braking force generated by the brake fitted to a wheel of the autonomous motor vehicle. The control device includes an automatic piloting system, which is configured to generate an automatic driving instruction for automatically driving the vehicle, a primary command chain, which includes a primary controller configured to generate a primary command according to the automatic driving instruction, and at least one primary actuator configured to generate a torque that confers a steering angle to the steered wheel, or configured to actuate the brake based on the primary command obtained directly from the primary controller. A secondary command chain is also included.

### CROSS-REFERENCE TO RELATED APPLICATIONS

This application is a U.S. non-provisional application claiming the benefit of French Application No. 21 03097, filed on Mar. 26, 2021, which is incorporated herein by reference in its entirety.

### FIELD The present invention relates to a control device for controlling the steering angle of an autonomous motor vehicle or braking of the autonomous motor vehicle.

The present invention further relates to an autonomous motor vehicle comprising such a device.

The invention relates to the field of automatic piloting (or autopilot) of motor vehicles, in particular to the piloting safety of such vehicles.

### BACKGROUND

In order to be able to operate in total autonomy while it is boarding passengers, an autonomous motor vehicle must satisfy drastic safety constraints. In particular, the vehicle must be capable of detecting an operating failure, in order to be able to act to secure vehicle safety.

In particular, the actuators that provide the ability to brake the vehicle or to control the steering must receive commands that are integral, that is to say having no aberrant values, and corresponding to instructions determined for the piloting.

The safety of the commands can be augmented by means of redundancies in the computation of these commands prior to sending them to the actuators.

For example, the document U.S. Pat. No. 10,202,090 B2 describes three processors that compute the commands that are sent to a programmable logic component, which selects one of the computed commands and transmits it to the actuators.

However, such systems can be further improved. In particular, such systems are dependent on proper operation of the programmable logic component.

An object of the invention is thus then to obtain a control device for controlling the steering angle of an autonomous motor vehicle or the braking of the autonomous motor vehicle, that is particularly simple, while also ensuring high reliability.

### SUMMARY

To this end, the subject-matter of the invention relates to a control device for controlling an autonomous motor vehicle in order to modify a steering angle of a steered wheel of the autonomous motor vehicle and/or a braking force generated by the brake fitted to a wheel of the autonomous motor vehicle, the control device comprising:
an automatic piloting system, which is configured to generate an automatic driving instruction for automatically driving the vehicle;
a primary command chain, which comprises a primary controller, configured to generate a primary command according to the automatic driving instruction, and at least one primary actuator, configured to generate a torque that confers a steering angle to the steered wheel, or configured to actuate the brake based on the primary command obtained directly from the primary controller;
a secondary command chain, which is distinct and separate from the primary command chain, comprising a secondary controller configured to:
   generate a secondary command according to the said automatic driving instruction;
   compare the said secondary command with the said primary command transmitted by the primary controller to the secondary controller; and
   emit a first failure signal when the primary command differs from the secondary command;
a reference controller, configured to:
   generate a reference command according to the automatic driving instruction;
   compare the reference command with the primary command transmitted by the primary controller to the reference controller, and
   emit a second signal failure when the primary command differs from the reference command;
an operation module, configured to interrupt an operation of the primary controller upon reception of both the first failure signal and the second failure signal;

the secondary command chain in addition comprising a secondary actuator, which acts to serve as redundancy for the primary actuator when the primary controller is interrupted, the secondary actuator being configured to generate a torque that confers a steering angle to the steered wheel, or configured to actuate the brake, based on the secondary command obtained directly from the secondary controller.

According to other advantageous aspects of the invention, the control device comprises one or more of the following characteristic features, taken into consideration in isolation or according to all the technically possible combinations:
the secondary controller is synchronised with the primary controller so as to ensure that the primary and secondary commands are generated simultaneously; and/or

the reference controller is synchronised with at least one controller from among the primary and secondary controllers, so as to ensure that the reference command and the command generated by the said at least one controller are generated simultaneously;
the primary controller is configured to compare the primary command with the secondary command, and to emit a third failure signal when the primary command differs from the secondary command;

the reference controller being further configured to compare the reference command with the secondary command, and to emit a fourth failure signal when the secondary command differs from the reference command;

the control device further comprising an additional operation module, configured to interrupt the operation of the secondary controller upon reception of both the third failure signal and the fourth failure signal;
the reference controller is configured, when it emits both the second failure signal and the fourth failure signal, to transmit a vehicle safety signal for securing the vehicle, to the automatic piloting system;
the automatic piloting system is connected to the primary controller, to the reference controller, and to the secondary controller both by a first communication bus and by a second communication bus, that is distinct and separate from the first communication bus, at least one of the said controllers being configured to periodically emit a life signal that is specific to this controller, on the first communication bus and on the second communication bus, in order to determine the state of operation of the first communication bus and of the second communication bus;
at least one controller from among the primary controller, the secondary controller and the reference controller, referred to as the transmitting controller, is configured to periodically emit a life signal that is specific to the transmitting controller, on a third communication bus that connects the said primary controller to the primary actuator, to the reference controller and to the secondary controller; and/or configured to periodically emit the life signal that is specific to the transmitting controller, on a fourth communication bus, which is distinct and separate from the third communication bus that connects the secondary controller to the secondary actuator, to the reference controller and to the primary controller;

and at least one controller from among the primary controller, the secondary controller and the reference controller, other than the transmitting controller, is configured to determine the state of operation of the third communication bus and/or of the fourth communication bus on the basis of the said life signal received from the transmitting controller;
the control device comprises two distinct and separate electrical power supply sources, of which a first source is configured to supply power to the primary command chain and a second source is configured to supply power to the secondary command chain;
the automatic driving instruction comprises an automatic steering instruction, the primary command comprises a primary steering command that enables the primary actuator to generate a torque that confers a steering angle to the steered wheel, and the secondary command comprises a secondary steering command that enables the secondary actuator to generate a torque that confers a steering angle to the steered wheel;
the primary actuator is configured to generate the torque only when it receives an activation signal from the primary controller, with the primary actuator generating no torque otherwise; and/or

the secondary actuator is configured to generate the torque only when it receives an activation signal from the secondary controller, with the secondary actuator generating no torque otherwise;
the control device comprises at least one current sensor configured to measure the intensity of an electric current supplying power to the primary actuator or the secondary actuator;

the primary controller being configured to command the stopping of the primary actuator when the intensity of the current measured by the current sensor is greater than a threshold value and when the secondary actuator generates the torque that confers a steering angle to the steered wheel; and/or the secondary controller being configured to interrupt the power supply to the secondary actuator when the intensity of the current measured by the current sensor is greater than a threshold value and when the primary actuator generates the torque that confers a steering angle to the steered wheel;
the automatic driving instruction comprises an automatic braking instruction, the primary command comprises a primary braking command that enables the primary actuator to apply a hydraulic pressure to the brake in accordance with the said primary braking command so as to ensure that the brake in turn apply a braking force to the wheel that is provided with the brake, and the secondary command comprises a secondary braking command that enables the secondary actuator to generate a hydraulic pressure at the brake in accordance with the said secondary braking command so as to ensure that the brake in turn apply a braking force to the wheel that is provided with the brake;
the control device comprises at least two primary actuators, of which one is an electrically controlled brake and the other one is a regenerative brake integrated in an electric motor of the vehicle, each of the electrically controlled brake and the regenerative brake being configured to apply a braking force based on the primary braking command;
the primary controller is configured to activate the secondary actuator after a predetermined time period during which the primary actuator is activated in order to maintain/keep the vehicle in stationary position;
the control device further comprises at least one pressure sensor configured to measure a hydraulic pressure present in the brake, and to transmit a measurement of the hydraulic pressure to the primary controller or to the secondary controller with the objective of establishing the diagnostics of the operation of the primary actuator and/or of the secondary actuator.

The invention also relates to an autonomous motor vehicle comprising at least one wheel that is provided with brake that are capable of applying a braking force to the said wheel, and at least one steered wheel, the vehicle comprising a control device as described above.

### BRIEF DESCRIPTION OF THE DRAWINGS

These characteristic features of the invention will become more clearly apparent upon reading the description which follows, given solely by way of non-limiting example, and made with reference to the appended drawings, in which:

FIG. 1 is a schematic representation of an autonomous motor vehicle comprising a control device according to a first embodiment of the invention; and;

FIG. 2 is a schematic representation that is analogous to FIG. 1 according to a second embodiment of the invention.

### DETAILED DESCRIPTION

### First Embodiment: Steering

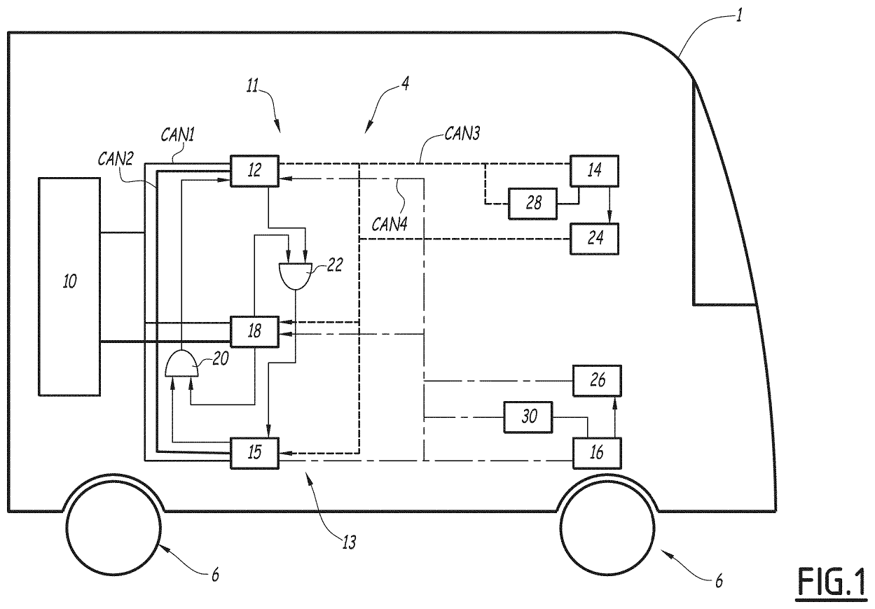

In FIG. 1, an autonomous motor vehicle 1 according to a first embodiment comprises a control device 4 and a plurality of wheels 6.

In this first embodiment, at least one of the wheels 6 is a steered wheel and the control device 4 is designed to automatically pilot the vehicle 1 by modifying a steering angle of the steered wheel.

The control device 4 comprises: an automatic piloting system 10; a primary command chain 11 constituted of a primary controller 12, a primary actuator 14, a first angle sensor 24, and a first current sensor 28; a secondary command chain 13 constituted of a secondary controller 15, a secondary actuator 16, a second angle sensor 26, and a second current sensor 30; and a reference controller 18.

The device 4 includes an operation module 20 that performs a logical operation between two failure signals relating to the primary controller 12, received respectively from the secondary controller 15 and from the reference controller 18, in order to generate an interrupt signal INT1, which is applied to the primary controller 12 and which deactivates it in the event of detection of a malfunction of the primary controller 12.

The operation module 20 is configured to interrupt the operation of the primary controller 12.

The expression “interrupt the operation of the primary controller”, is understood to refer to the cutting-off of the electrical power supply to the primary controller 12.

The device 4 preferably comprises an additional operation module 22 that performs a logical operation between two failure signals relating to the secondary controller 15, received respectively from the primary controller 12 and the reference controller 18, in order to generate an interrupt signal INT2, which is applied to the secondary controller 15 and which deactivates it in the event of detection of a malfunction of the secondary controller 15.

The additional operation module 22 is configured to interrupt the operation of the secondary controller 15.

The expression “interrupt the operation of the secondary controller”, is understood to refer to the cutting-off of the electrical power supply to the secondary controller 15.

The control device 4 comprises the first, second, third, and fourth communication buses, respectively CAN1, CAN2, CAN3 and CAN4. The first, second, third, and fourth buses are distinct and separate. In particular, no exchange of data is possible between the buses CAN1 to CAN4 with respect to each other. For example, the first, second, third, and fourth communication buses implement the communication protocol CanBus.

The first bus CAN1 connects an output of the system 10 to an input of the primary controller 12, to an input of the secondary controller 15, and to an input of the reference controller 18. In addition, the bus CAN1 also connects the outputs of the controllers 12, 15 and 18 to an input of the system 10.

Serving as redundancy for the first bus, the second bus CAN2 connects the output of the system 10 to the input of the primary controller 12, to the input of the secondary controller 15, and to the input of the reference controller 18. In addition, the bus CAN2 also connects the outputs of the controllers 12, 15 and 18 to an input of the system 10. The second bus CAN2 is optional. It makes it possible to enhance the safety of the control device 4 by preferably supplying the same signal as the first bus CAN1. The third bus CANS connects an output of the primary controller 12 to an input of the primary actuator 14, but also to an input of the secondary controller 15, and to an input of the reference controller 18. The third bus also connects the primary sensors 24 and 28 at the input of the primary controller 12.

In a symmetrical manner, the fourth bus CAN4 connects an output of the secondary controller 15 to an input of the secondary actuator 16, but also to an input of the primary controller 12, and to an input of the reference controller 18. The fourth bus also connects the secondary sensors 26 and 30 at the input of the secondary controller 15.

Preferably, the control device 4 comprises two electrical power supply sources (not represented in FIG. 1), which are distinct and separate from one another. The first source is configured to supply power to the primary command chain 11. The second source is configured to supply power to the secondary command chain 13. This makes it possible to avoid common modes of failure associated with the electrical power supply.

Preferably, and with the exception of the other elements of the secondary command chain 13, the reference controller 18 is capable of being powered either by the first or by the second power supply source. For example, the reference controller 18 is configured to be supplied power by the first source.

Preferably, the control device 4 comprises at least one manual piloting device, not represented, configured to generate a manual steering command and/or a manual stop command. Such a manual piloting device allows an operator either to drive the vehicle (manual piloting phase), or to regain control of the piloting of the vehicle in the event of identification by the operator of a problem (phase of vehicle testing).

The automatic piloting system 10 is for example a computer comprising a memory storage unit and a processor. It is for example programmed to compute a trajectory that the vehicle 1 must follow and to generate, at each instant of sampling of the control device 4, an automatic vehicle driving instruction. In the first embodiment, the automatic driving instruction delivered by the system 10 is a steering instruction CNS1 and CNS2 relating to the angle of the steered wheel.

The system 10 is capable of sending the steering instruction CNS1 on the first bus CAN1. Advantageously, a replica of the steering instruction CNS2 is sent on the second bus CAN2. This serves to enable the controller 12 and 15 to check and verify the consistency between the instructions, and if the instructions are not consistent, to emit a command for securing vehicle safety, such as a stop command.

The primary controller 12 is for example a computer comprising a memory storage unit and a processor. It is programmed to generate a primary command CMD1 according to the instruction CNS1 received from the system 10.

The primary controller 12 is capable of sending the primary command CMD1 so generated on the third bus CAN3, intended to be received by the primary actuator 14, as also the secondary controller 15, and the reference controller 18.

The primary actuator 14 is an electrically controlled actuator. The primary actuator 14 is for example a product sold off the shelf, also referred to as a COTS (for Commercial off-the-shelf) product.

The primary actuator 14 incorporates a motor that is capable of exerting a mechanical torque that makes it possible to modify the angle of steering of the steered wheel. This torque is generated on the basis of the primary command CMD1, directly received from the primary controller 12.

The term “directly received”, is understood to refer to the reception via transmission by a bus, here the third bus CAN3, with the command not having to pass through any other elements.

Preferably, the primary actuator 14 is activated only when the secondary actuator 16 is deactivated, and is deactivated when the secondary actuator is activated. For example, the primary actuator 14 is activated when it receives an activation signal from the primary controller 12. When the primary controller 12 is deactivated, it is no longer able to emit this activation signal, which has the consequence of deactivating the primary actuator 14. This activation signal is also transmitted by the primary controller 12 on the third bus CAN3.

According to one example, the primary actuator 14 is capable of receiving an interrupt signal from the primary controller 12, for example if the controller 12 detects a malfunction of the actuator 14.

The primary actuator 14 further comprises an internal sensor capable of generating an internal measurement signal, corresponding to a measurement of the steering angle conferred by the primary actuator 14, and for transmitting it to the primary controller 12 via the third bus CAN3.

Serving as redundancy for the internal sensor of the primary actuator 14, the first angle sensor 24 measures a steering angle that is actually conferred by the primary actuator 14 to the steered wheel.

The angle sensor 24 is independent of the actuator 14 and provides the means to obtain, in addition to the internal measurement signal, another measurement of the steering angle for the purposes of diagnostics relating to the proper operation of the actuator 14. The angle sensor 24 is configured to transmit the measurement acquired to the primary controller 12. The latter is configured to perform the said diagnostics and detect the occurrence of a failure of the primary actuator 14.

The first current sensor 28 detects the level of the electrical power supply to the primary actuator 14. In particular, the first current sensor 28 is configured to measure the intensity of electrical current being supplied to the primary actuator 14.

The first current sensor 28 is connected to the third bus CAN3 so as to transmit, to the primary controller 12, a measurement signal for measuring the electrical power supply to the primary actuator 14 that enables the primary controller 12 to command the stopping of the primary actuator 14 when the torque on the steered wheel is to be exerted by the secondary actuator 16, in the event of the measurement signal comprising a value for the current intensity as measured by the first current sensor 28 that is greater than a threshold value. This serves to prevent both the actuator 14 and the actuator 16 from exerting a torque.

Thanks to the first current sensor 28 that makes it possible to detect untimely or inadvertent operation of the actuator 14, together with the monitoring of the primary command CMD1 by the secondary controller 15 and the reference controller 18, the robustness of the primary command chain 11 is augmented.

Thanks to the comparison of the measurement signal for internal measurement of the steering angle with the measurement from the first angle sensor 24, combined with the monitoring of the primary command CMD1 by the secondary controller 15 and the reference controller 18, the robustness of the primary command string 11 is also augmented.

For example, each of the elements of the primary command chain 11 is monitored by two other elements: the primary actuator 14 is monitored via the current sensor 28 and via the comparison of the internal measurement signal with the measurement signal from the angle sensor 24; the primary controller 12 is monitored via the controllers 15 and 18.

The secondary command chain 13 provides redundancy for the primary chain 11. It is distinct and separate from the primary command chain so as to avoid failure modes common to both chains.

The secondary controller 15 is for example a computer comprising a memory storage unit and a processor. It is programmed to generate a secondary command CMD2 according to the instruction CNS1 received from the system 10 and/or the instruction CNS2. The secondary controller 15 is synchronised with the primary controller 14 so as to generate the secondary command CMD2 simultaneously with the generation of the primary command CMD1 by the primary controller 12. The secondary controller 15 forms a so-called “hot” redundancy for the primary controller 12.

The secondary controller 15 is capable of sending the secondary command CMD2 on the fourth bus CAN4 intended to be received by the secondary actuator 16, as also the primary controller 12, and the reference controller 18.

The secondary actuator 16 is similar to the primary actuator 14. The secondary actuator 16 forms a so-called “cold” redundancy for the actuator 14. It is activated only when the primary actuator 14 and the primary controller 12 are inactivated as will be described below. For example, in order to be activated, the secondary actuator 16 receives an activation signal from the secondary controller 15. Once activated, the secondary actuator 16 is capable of taking into account the secondary command CMD2, directly received from the secondary controller 15. It then applies a torque that confers a steering angle to the steered wheel in place of the primary actuator 14. The steering angle applied is a function of the secondary command CMD2.

The second angle sensor 26 measures the steering angle actually conferred by the secondary actuator 16 to the steered wheel. This measurement of steering angle is effected in addition to that performed by the internal sensor of the secondary actuator 16. The angle sensor 26 is used in the secondary command chain like the angle sensor 24 in the primary command chain.

The second current sensor 30 detects the level of the electrical supply to the secondary actuator 16. The current sensor 30 exhibits an operation analogous to the current sensor 28.

As indicated above, the primary 11 and secondary command chains 13 are distinct and separate. Preferably, the primary controller 12 is capable of sending the command to the primary actuator 14, but is unable to send this command to the secondary actuator 16 according to the first embodiment. This is illustrated in FIG. 1 which shows an arrow of the fourth bus CAN4 entering the primary controller 12, which thus then symbolises that the primary controller is unable to send the command via the fourth bus CAN4, preferably with the exception of a life signal described here below.

The device 4 is configured in order to implement mutual monitoring of the proper operation of the controllers 12 and 15 by using the reference controller 18 and the operation modules 20, 22, as will be described here below.

The reference controller 18 is for example a computer comprising a memory storage unit and a processor. It is programmed to compute a reference command on the basis of the instruction CNS1 and/or CNS2 received from the system 10.

It is programmed to compare this reference command with the primary command CMD1 received from the primary controller 12 for the same time step.

Preferably, the controller 18 is synchronised with the primary controller 12 so as to generate the reference command simultaneously with the generation of the primary command. As an optional addition, the controller 18 is synchronised with the secondary controller 15 so as to generate the reference command simultaneously with the generation of the secondary command.

Preferably, the primary controller 12, the secondary controller 15, and the reference controller 18 comprise internal computation instructions which make it possible to obtain commands that are identical to each other in the absence of a failure. Preferably, these instructions are coded in a different manner on the three controllers. This makes it possible to prevent the non-detection of code errors propagated across the three controllers which would in fact become undetectable.

When the primary command CMD1 differs from the reference command, considering thus then that the primary controller 12 is faulty, the reference controller 18 sends a failure signal DEF1 to the operation module 20.

The reference controller 18 is also programmed to compare this reference command with the secondary command CMD2 received from the secondary controller 15 for the same time step.

When the secondary command CMD2 differs from the reference command, considering thus then that the secondary controller 15 is faulty, the reference controller 18 sends a failure signal DEF2 to the additional operation module 22.

The primary controller 12 is configured to compare the secondary command CMD2, received at the current time instant from the secondary controller 15, with the primary command CMD1, which it computed at the same time instant.

When the primary command CMD1 differs from the secondary command CMD2, considering thus then that secondary controller 15 is faulty, the primary controller 12 sends a failure signal DEF3 to the additional operation module 22.

Similarly, the secondary controller 15 is configured to compare the primary command CMD1, received at the current time instant from the primary controller 12, with the secondary command CMD2, which it computed at the same time instant.

When the secondary command CMD2 differs from the primary command CMD1, considering thus then that primary controller 12 is faulty, the secondary controller 15 sends a fourth failure signal DEF4 to the operation module 20.

The operation module 20 is for example configured to perform an ET type operation on the signals DEF1 and DEF4 from the secondary controller 15 and the reference controller 18.

The interrupt signal INT1 produced is applied to the primary controller 12. When the level of the signal INT1 is low, the primary controller 12 remains activated and it is the primary command chain 11 that manages the steering of the steered wheel. When the level of the signal INT1 is high, which corresponds to the reception by the module 20 of both the signal DEF1 and the signal DEF4, the primary controller 12 is deactivated and the secondary controller 15 is activated and it is the secondary command chain 13 that manages the steering of the steered wheel.

The additional operation module 22 is for example configured to perform an ET type operation on the signals DEF2 and DEF3 from the reference controller 18 and the primary controller 12.

The interrupt signal INT2 produced is applied to the secondary controller 15. When the level of the signal INT2 is low, the secondary controller 15 remains in its current mode of operation (if it was inactive, it remains inactive, if it is activated, it remains activated). When the level of the signal INT2 is high, which corresponds to the reception by the module 22 of both the signal DEF2 and the signal DEF3, the secondary controller 15 is deactivated. If it was active, then the control device 4 switches into a safe fallback state leading to an emergency stopping of the vehicle 1.

If it was already inactive, nothing changes since it is the primary chain that manages the steering of the steered wheel. However, due to the fact that now the redundancy provided by the secondary command chain is missing, the primary controller 12 preferably commands a stopping of the vehicle 1, for example at a subsequent planned stop station. In addition, if the primary chain then experiences a failure, the device 4 immediately switches to the safe fallback state, involving for example an immediate stopping of the vehicle 1.

During the operation of the control device, preferably, the proper operation of the first, second, third, and fourth bus CAN1 to CAN4 is monitored.

In order to do this, at least one of the controllers 12, 15, 18 periodically emits a life signal specific to this controller 12, 15, 18 on at least one bus from among the first bus CAN1, the second bus CAN2, the third bus CAN3, and the fourth bus CAN4, in order to determine the state of operation of the one or more communication bus(es) CAN1 to CAN4 on which the life signal is emitted.

For example, the primary controller 12 emits, on the first bus CAN1, a life signal comprising a characteristic specific to the controller 12 and comprising a counter value which is incremented each time the life signal is emitted. The life signal further comprises a checksum generated on the basis of the characteristic and the counter.

The controller 15 comprises a counter which is incremented each time the life signal is received from the primary controller 12. The controller 15 compares the counter value of the life signal received with its own counter in order to determine whether it has actually received the current life signal. Also, the controller 15 computes the checksum on the basis of the life signal received and compares it with the checksum included in the said signal. This makes it possible to determine the proper functioning of the first bus CAN1.

In addition, the primary controller 12 emits the life signal also on the buses CAN2, CAN3 and CAN4 for analogous monitoring of these buses.

In addition, the controller 18 checks and verifies in the same manner, the operation of the buses CAN1 to CAN4.

Preferably, each controller 12, 15, 18 emits a life signal of the aforementioned type on each bus CAN1 to CAN4, which is analysed by the two other controllers that receive the respective life signal. This makes it possible to determine the proper operation of all the buses CAN1 to CAN4, and also to check and verify that one of the controllers 12, 15 or 18 has not been interrupted.

During nominal operation, the primary command chain 11 and the secondary command chain 13 are alternately operational. This makes it possible to anticipate a failure of the primary command chain 11 and to reduce the wear of the primary actuator 14. For example, the controller 12 or 15 of the command chain which is operational at a given time instant comprises a token indicating that this chain is operational. Preferably, the controller 15 verifies that only one of the controllers 12 and 15 has this token, and otherwise, it induces a command for the vehicle to be stopped, for example by a command to the system 10.

In the following section/s, cases of failure of a part of the control device 4 are described. The following table summarises the cases of failure of the controllers 12 and 15 for the case wherein the controller 18 is operational without failure. In the first line and the first column are indicated the states of the controllers 12 and 15.

The term “functional” state, is understood to indicate that the interrupt signal INTI , INT2 intended to be received by this controller is low, and the term “non-functional” state, is understood to indicate that the corresponding interrupt signal is high.

The four cases of the table show the consequences for the control device 4 for the combinations of states of the controllers 12 and 15, described here below.

When the controller 12 and the controller 15 are functional, generally the actuator 14 generates the steering torque according to the primary command CMD1, with the exception of the optional configuration described here above, according to which the piloting system 10 commands a switchover from the primary chain 11 to the secondary chain 13 after a predetermined period of operation. The actuator 16 is inactive because it receives no activation signal.

When the controller 12 is functional, but the controller 15 is not functional, the primary chain 11 remains active and the actuator 14 pilots the steered wheel.

When the controller 12 is non-functional, but the controller 15 is functional, the primary controller 12 is then deactivated and the secondary controller 15 activates the secondary actuator 16 to pilot the steered wheel.

When both the controller 12 and the controller 15 are non-functional, an emergency stop is commanded by the system 10.

For example when the controller 18 emits both the failure signal DEF1 and DEF2, considering thus then the two controllers 12 and 15 are faulty, the controller 18 sends a command, via the system 10, for securing of the vehicle safety, such as a stop at the subsequently scheduled station.

TABLE 1

| | Controller 12 | Controller 12 |
|---|---|---|
| | functional | not functional |
| Controller 15 | Actuator 14 pilots the | Actuator 16 pilots the steered |
| functional | steered wheel/actuator | wheel/controller 12 and |
| | 16 inactive | actuator 14 inactive |
| Controller 15 | Actuator 14 pilots the | Emergency stop |
| not functional | steered wheel/actuator | without control |
| | 16 inactive | of steering |

If the controller 12 or 15 does not receive the life signal from the controller 18 via the buses CAN1 to CAN4, it determines that the controller 18 is non-functional. In this case, the controller 12 or 15 sends a signal to the control system 10 to command the securing of the vehicle safety, such as with an emergency stop. Preferably, the command chain that is active when the failure of the controller 18 is noted, remains active until the vehicle 1 stops.

The present architecture makes it possible to dispense with the implementation of a programmable polling component at the output of the computers. It being acknowledged that such a component is tedious and cumbersome to implement, the present architecture constitutes a simplification that makes it possible to achieve at a lower cost the level of safety required for an automatic vehicle.

Also, the robustness of operation of the device 4 is enhanced, because thanks to the comparison of failure signals, only the stopping of a controller is commanded if the two other controllers share the assessment that this first controller is faulty, and thus then send the corresponding failure signals.

### Second Embodiment: Braking

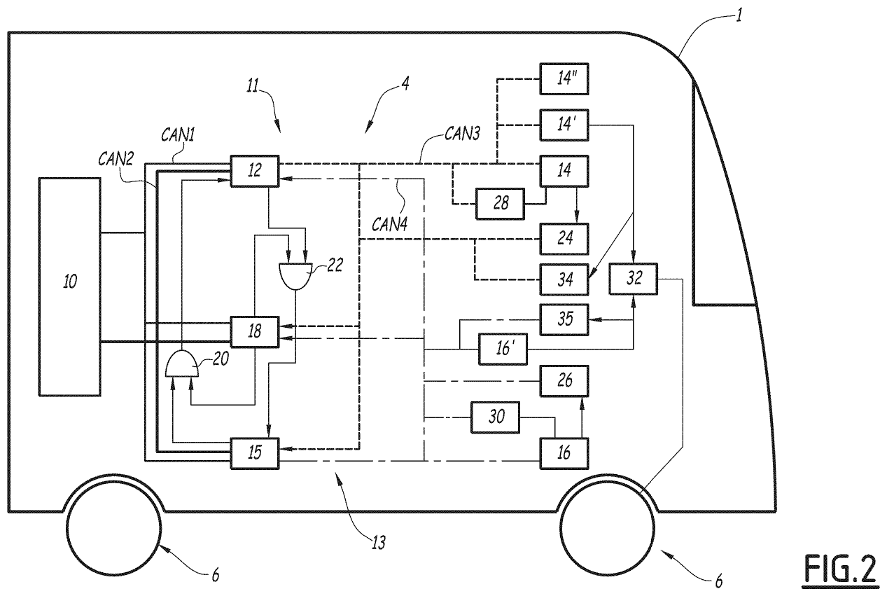

A second embodiment of the vehicle according to the invention is described with reference to FIG. 2.

An element in FIG. 2 that is similar to an element in FIG. 1 is denoted in FIG. 2 by a reference numeral that is identical to the one used to denote this analogous element in FIG. 1.

In this second embodiment, the vehicle 1 comprises at least one wheel 6 which is equipped with brake 32 capable of applying a braking force to the wheel.

The control device 4 is thus then configured to control the braking of the vehicle 1. In order to do this, the automatic driving instruction is an automatic braking instruction, the primary command is a primary braking command, and the secondary command is a secondary command braking.

The architecture of the control device 4 of FIG. 2 is identical to that of the control device 4 of FIG. 1, with the exception being the differences described here below.

The mechanical part is different as compared to the first embodiment, making it possible to actuate braking instead of steering.

The control device 4 thus preferably comprises a primary actuator 14′ which is an electrically controlled brake and a primary actuator 14″ which is a regenerative brake integrated in an electric motor, not represented, of the vehicle 1.

The control device 4 comprises a secondary actuator 16′ which is an auxiliary brake.

The control device 4 further comprises at least one pressure sensor configured to measure the hydraulic pressure applied in the brake 32. In the example shown in FIG. 2, the control device 4 comprises a first pressure sensor 34 configured to measure a hydraulic pressure applied in the brake 32 by the primary actuator 14′ and the secondary actuator 16′, and a second pressure sensor 35 configured to measure the hydraulic pressure applied in the brake 32 by the secondary actuator 16′.

In addition, the control device 4 preferably comprises at least one manual piloting device, not represented, configured to generate a manual braking command and/or a manual stop command. Such a manual piloting device serves to enable an operator either to drive the vehicle (manual piloting phase), or to regain control of the piloting of the vehicle in the event of identification by the operator of a problem (phase of vehicle testing).

The primary actuator 14′ is configured to generate, by electrical control, a hydraulic pressure in accordance with the primary braking command to the brake 32 in order to apply a braking force to the wheel 6 as a function of the hydraulic pressure.

The primary actuator 14′ is connected to the third bus CAN3 so as to receive the primary braking command directly from the primary controller 12.

The primary actuator 14″ is configured to induce an induction within the electric motor of the vehicle 1, in order to apply a braking force for braking the vehicle 1. The primary actuator 14″ is connected to the third bus CAN3 so as to receive the primary braking command directly from the primary controller 12 thereby making it possible to apply the braking force.

The secondary actuator 16′ is configured to apply, replacing or in addition to the primary actuator 14′, hydraulic pressure on the brake 32.

The secondary actuator 16′ is connected to the bus CAN4 so as to receive the secondary command CMD2 directly from the secondary controller 15 and to apply a hydraulic pressure in accordance with the command CMD2.

In addition, the secondary actuator 16′ is also capable of receiving the primary command CMD1 via the bus CAN4 and of applying a hydraulic pressure in accordance with the command CMD1. This is illustrated in FIG. 2, in which the input/output of the bus CAN4 of the primary controller has no arrow, this connection thus being bidirectional and enabling the primary command CMD1 to be transmitted.

Unlike the first embodiment, the primary controller 12 is thus preferably capable of sending the primary command CMD1 also to the secondary actuator 16′, and not only to the primary actuator 14′, 14″.

The brake 32 comprise for example a primary circuit, not represented, connected to the primary actuator 14′ which is configured to generate a pressure in the primary circuit, and a secondary circuit, connected to the secondary actuator 16′ which is configured to generate a pressure in both the primary circuit and the secondary circuit.

The first pressure sensor 34 is configured to transmit a measurement signal to the controller 12 via the bus CAN3, corresponding to a hydraulic pressure exerted in the primary circuit, so as to enable the controller 12 to determine whether this measured hydraulic pressure is in accordance with the command CMD1 or CMD2, and to diagnose a failure of the actuator 14′ or 16′ as may be necessary.

The second pressure sensor 35 is configured to transmit a measurement signal to the controller 15 via the bus CAN4, corresponding to a hydraulic pressure exerted in the secondary circuit, so as to enable the controller 15 to determine whether this measured hydraulic pressure is in accordance with the command CMD1 or CMD2, when the secondary actuator 16′ exerts a pressure.

The operation of the controllers 12, 15 and 18 of the second embodiment is preferably identical to that of the first embodiment, in particular as regards the mutual monitoring of the controllers.

According to the second embodiment, the primary controller 12 is configured to activate the secondary actuator 16′ so as to generate the hydraulic pressure to the brake 32, after a predetermined time period from braking to the stopping of the vehicle 1 during which the primary actuator 14′ generates the hydraulic pressure. The predetermined duration is for example 120 seconds.

The person skilled in the art will understand that the first embodiment and the second embodiment may be combined. In this case, the automatic driving instruction preferably comprises both the automatic steering instruction and the automatic braking instruction. Preferably, the primary command includes both the primary steering command and the primary braking command. The secondary command preferably includes both the secondary steering command and the secondary braking command.

The person skilled in the art will also understand that the device 4 is capable of monitoring the primary command CMD1 and the secondary command CMD2 of any type of commands for controlling the driving of the vehicle 1. For example, the primary command and the secondary command includes a traction instruction for piloting the motor of the vehicle 1.

What is claimed is:

1. A control device for controlling an autonomous motor vehicle in order to modify a steering angle of a steered wheel of the autonomous motor vehicle and/or a braking force generated by the brake fitted to a wheel of the autonomous motor vehicle, the control device comprising:
an automatic piloting system, which is configured to generate an automatic driving instruction for automatically driving the vehicle;
a primary command chain, which comprises a primary controller, configured to generate a primary command according to the automatic driving instruction, and at least one primary actuator, configured to generate a torque that confers a steering angle to the steered wheel, or configured to actuate the brake based on the primary command obtained directly from the primary controller;
a secondary command chain, which is distinct and separate from the primary command chain, comprising a secondary controller configured to:
generate a secondary command according to said automatic driving instruction;
compare said secondary command with said primary command transmitted by the primary controller to the secondary controller; and
emit a first failure signal when the primary command differs from the secondary command;
a reference controller, configured to:
generate a reference command according to the automatic driving instruction;
compare the reference command with the primary command transmitted by the primary controller to the reference controller; and
emit a second failure signal when the primary command differs from the reference command;
an operation module, configured to interrupt an operation of the primary controller upon reception of both the first failure signal and the second failure signal;
the secondary command chain in addition comprising a secondary actuator, which acts to serve as redundancy for the primary actuator when the primary controller is interrupted, the secondary actuator being configured to generate a torque that confers a steering angle to the steered wheel, or configured to actuate the brake, based on the secondary command obtained directly from the secondary controller.

2. A control device according to claim 1, in which
the secondary controller is synchronised with the primary controller so as to ensure that the primary and secondary commands are generated simultaneously; and/or
the reference controller is synchronised with at least one controller from among the primary and secondary controllers, so as to ensure that the reference command and the command generated by said at least one controller are generated simultaneously.

3. A control device according to claim 1, in which the primary controller is configured to compare the primary command with the secondary command, and to emit a third failure signal when the primary command differs from the secondary command;
the reference controller being further configured to compare the reference command with the secondary command, and to emit a fourth failure signal when the secondary command differs from the reference command;
the control device further comprising an additional operation module, configured to interrupt the operation of the secondary controller upon reception of both the third failure signal and the fourth failure signal.

4. A control device according to claim 3, in which the reference controller is configured, when it emits both the second failure signal and the fourth failure signal, to transmit a vehicle safety signal for securing the vehicle, to the automatic piloting system.

5. A control device according to claim 1, in which the automatic piloting system is connected to the primary controller, to the reference controller, and to the secondary controller both by a first communication bus and by a second communication bus, that is distinct and separate from the first communication bus, at least one of said controllers being configured to periodically emit a life signal that is specific to this controller, on the first communication bus and on the second communication bus, in order to determine the state of operation of the first communication bus and of the second communication bus.

6. A control device according to claim 1, in which at least one controller from among the primary controller, the secondary controller and the reference controller, referred to as the transmitting controller, is configured to periodically emit a life signal that is specific to the transmitting controller, on a third communication bus that connects said primary controller to the primary actuator, to the reference controller and to the secondary controller; and/or configured to periodically emit the life signal that is specific to the transmitting controller, on a fourth communication bus, which is distinct and separate from the third communication bus that connects the secondary controller to the secondary actuator, to the reference controller and to the primary controller;
and in which at least one controller from among the primary controller, the secondary controller and reference controller, other than the transmitting controller, is configured to determine the state of operation of the third communication bus and/or of the fourth communication bus on the basis of said life signal received from the transmitting controller

7. A control device according to claim 1, in which the control device comprises two distinct and separate electrical power supply sources, of which a first source is configured to supply power to the primary command chain and a second source is configured to supply power to the secondary command chain.

8. A control device according to claim 1, in which the automatic driving instruction comprises an automatic steering instruction, the primary command comprises a primary steering command that enables the primary actuator to generate a torque that confers a steering angle to the steered wheel, and the secondary command comprises a secondary steering command that enables the secondary actuator to generate a torque that confers a steering angle to the steered wheel.

9. A control device according to claim 8, in which the primary actuator is configured to generate the torque only when it receives an activation signal from the primary controller, with the primary actuator generating no torque otherwise; and/or
the secondary actuator is configured to generate the torque only when it receives an activation signal from the secondary controller, with the secondary actuator generating no torque otherwise.

10. A control device according to claim 8, the control device comprising at least one current sensor configured to measure the intensity of an electric current supplying power to the primary actuator or the secondary actuator;
the primary controller being configured to command the stopping of the primary actuator when the intensity of the current measured by the current sensor is greater than a threshold value and when the secondary actuator generates the torque that confers a steering angle to the steered wheel; and/or the secondary controller being configured to interrupt the power supply to the secondary actuator when the intensity of the current measured by the current sensor is greater than a threshold value and when the primary actuator generates the torque that confers a steering angle to the steered wheel.

11. A control device according to claim 1, in which the automatic driving instruction comprises an automatic braking instruction, the primary command comprises a primary braking command that enables the primary actuator to apply a hydraulic pressure to the brake in accordance with said primary braking command so as to ensure that the brake in turn apply a braking force to the wheel that is provided with the brake, and the secondary command comprises a secondary braking command that enables the secondary actuator to generate a hydraulic pressure at the brake in accordance with said secondary braking command so as to ensure that the brake in turn apply a braking force to the wheel that is provided with the brake.

12. A control device according to claim 11, the control device comprising at least two primary actuators, of which one is an electrically controlled brake and the other one is a regenerative brake integrated in an electric motor of the vehicle, each of the electrically controlled brake and the regenerative brake being configured to apply a braking force based on the primary braking command.

13. A control device according to claim 11, in which the primary controller is configured to activate the secondary actuator after a predetermined time period during which the primary actuator is activated in order to maintain/keep the vehicle in stationary position.

14. A control device according to claim 11, in which the control device further comprises at least one pressure sensor configured to measure a hydraulic pressure present in the brake, and to transmit a measurement of the hydraulic pressure to the primary controller or to the secondary controller for establishing the diagnostics of the operation of the primary actuator and/or of the secondary actuator.

15. An autonomous motor vehicle, comprising at least one wheel that is provided with brake that are capable of applying a braking force to said wheel, and at least one steered wheel, wherein the vehicle comprises a control device according to claim 1.
